(19) United States
(12) Patent Application Publication
(10) Pub. No.: US 2026/0246393 A1
(43) Pub. Date: Aug. 20, 2026

(54) POWER CONVERTER

(71) Applicant: CHICONY POWER TECHNOLOGY CO., LTD., New Taipei City (TW)

(72) Inventors: Huang-Ying CHEN, New Taipei City (TW); Guan-Chun HONG, New Taipei City (TW)

(21) Appl. No.: 19/247,023

(22) Filed: Jun. 24, 2025

(30) Foreign Application Priority Data
Feb. 17, 2025 (TW) 114105789

(51) Int. Cl. H02M 7/217

(52) U.S. Cl. CPC H02M 7/217

(57) ABSTRACT

A power converter includes a primary-side module and a secondary-side module. The primary-side module includes a step-up unit, a first adjustment unit, a conversion unit, and a first control unit. The secondary-side module includes a second adjustment unit, a feedback circuit, a detection unit, and a second control unit. The step-up unit provides a front-stage voltage. The first adjustment unit outputs a first voltage-dividing signal according to the front-stage voltage and a first feedback signal. The first control unit controls the step-up unit to adjust the front-stage voltage and controls the conversion unit to adjust an output voltage. The second adjustment unit outputs a second voltage-dividing signal. The feedback circuit provides the first feedback signal. The detection unit outputs a state voltage according to a load state. The second control unit outputs the first control signal and outputs a second control signal according to the second voltage-dividing signal.

### BACKGROUND

### Technical Field

The present disclosure relates to a power converter, and more particularly to a power converter that can maintain optimal efficiency by reducing the output voltage under a light-load operation.

### Description of Related Art

The statements in this section merely provide background information related to the present disclosure and do not necessarily constitute prior art.

Current power supply designs have increasingly higher efficiency requirements under light-load conditions. In addition to selecting low-power components in the circuit, the design can also reduce the supply voltage of the integrated circuit (IC), thereby reducing the loss of the IC. In particular, the most intuitive approach is to directly reduce the output voltage, for example, directly reducing the output voltage from 20 volts to 15 volts to reduce losses.

Please refer to FIG. 1, FIG. 2A, and FIG. 2B, which show a block diagram of a conventional charger circuit, a circuit diagram of an AC-to-DC rectifier and a primary-side conversion circuit in FIG. 1, and a circuit diagram of a secondary-side circuit in FIG. 1 respectively. The power conversion circuit shown in FIG. 1, taking a charger circuit as an example, includes an AC-to-DC rectifier 91, a primary-side conversion circuit 92, and a secondary-side circuit 93. The AC power (mains) is converted into a DC voltage by the AC-to-DC rectifier 91, and then the DC voltage is step up (boosted) to a high voltage, such as but not limited to, 400 volts, by the primary-side conversion circuit 92. This high voltage of 400 volts then powers the resonant circuit (LLC). Furthermore, the resonant circuit (LLC) transfers energy to the secondary side through the transformer, and the output voltage is regulated (stabilized) at, for example but not limited to, 20 volts by the operation of the secondary-side circuit 93.

However, for a power converter structure with a power factor correction circuit (PFC) and a resonant circuit (LLC), because of the influence of the LLC resonant tank, when the output voltage is decreased, the output voltage of the PFC must also be decreased synchronously, for example, from 400 volts to 300 volts, in order to maintain the optimal design of the resonant tank and optimize the efficiency of the power converter. In other words, if the output voltage is decreased in response to the system under light-load conditions, but the output voltage of the PFC is not decreased synchronously, the efficiency under light-load conditions will not be improved.

Therefore, how to design a power converter to solve the problems and technical bottlenecks in the existing technology has become a critical topic in this field.

### SUMMARY

An objective of the present disclosure is to provide a power converter. The power converter includes a primary-side module and a secondary-side module. The primary-side module includes a step-up unit, a first adjustment unit, a conversion unit, and a first control unit. The step-up unit provides a front-stage voltage. The first adjustment unit is coupled to the step-up unit, and the first adjustment unit outputs a first voltage-dividing signal according to the front-stage voltage and a first feedback signal. The conversion unit receives the front-stage voltage and output an output voltage. The first control unit is coupled to the step-up unit, the first adjustment unit, and the conversion unit, and the first control unit controls the step-up unit to adjust the front-stage voltage according to the first voltage-dividing signal, and controls the conversion unit to adjust the output voltage according to a second feedback signal. The secondary-side module is electrically isolated from the primary-side module. The secondary-side module includes a second adjustment unit, a feedback circuit, a detection unit, and a second control unit. The second adjustment unit outputs a second voltage-dividing signal according to the output voltage and a first control signal. The feedback circuit provides the first feedback circuit according to the first control signal. The detection unit outputs a state voltage according to a load state at an output terminal of the conversion unit. The second control unit is coupled to the second adjustment unit, the detection unit, and the feedback circuit, and the second control unit outputs the first control signal according to the state voltage and a reference voltage, and outputs a second control signal according to the second voltage-dividing signal.

In one embodiment, the first adjustment unit includes a first voltage-dividing circuit and a first voltage-transforming circuit. The first voltage-dividing circuit is coupled to the step-up unit, and the first voltage-dividing circuit outputs the first voltage-dividing signal. The first voltage-transforming circuit is coupled to the first voltage-dividing circuit, and the first voltage-transforming circuit receives the first feedback signal.

In one embodiment, the first voltage-dividing circuit includes a first resistor and a second resistor connected in series; a first terminal of the first resistor is coupled to the step-up unit, and a first terminal of the second resistor is coupled to a ground terminal of the primary-side module; a second terminal of the first resistor, a second terminal of the second resistor, the first control unit, and the first voltage-transforming circuit are coupled and output the first voltage-dividing signal.

In one embodiment, the first voltage-transforming circuit includes a first voltage-transforming resistor and a first switch component. The first voltage-transforming resistor is connected to the first voltage-dividing circuit in parallel. A first terminal of the first switch component is coupled to the second terminal of the first resistor and the second terminal of the second resistor; a second terminal of the first switch component is coupled to the first voltage-transforming resistor; a control terminal of the first switch component is coupled to a second coupling component. When the first switch component is turned off according to the first feedback signal, the first voltage-transforming resistor is not connected to the first resistor or the second resistor.

In one embodiment, the second adjustment unit includes a second voltage-dividing circuit and a second voltage-transforming circuit. The second voltage-dividing circuit outputs the second voltage-dividing signal according to the output voltage. The second voltage-transforming circuit is coupled to the second voltage-dividing circuit, and the second voltage-transforming circuit receives the first control signal.

In one embodiment, the second voltage-dividing circuit includes a third resistor and a fourth resistor connected in series; a first terminal of the third resistor is coupled to the output terminal, and a first terminal of the fourth resistor is coupled to a ground terminal of the secondary-side module; a second terminal of the third resistor, a second terminal of the fourth resistor, the second control unit, and the second voltage-transforming circuit are coupled and output the second voltage-dividing signal.

In one embodiment, the second voltage-transforming circuit includes a second voltage-transforming resistor and a second switch component. A second voltage-transforming resistor is connected to the second voltage-dividing circuit in parallel. A first terminal of the second switch component is coupled to the second terminal of the third resistor and the second terminal of the fourth resistor; a second terminal of the second switch component is coupled to the second voltage-transforming resistor; a control terminal of the second switch component receives the first control signal. When the second switch component is turned off according to the first control signal, the second voltage-transforming resistor is not connected to the third resistor or the fourth resistor.

In one embodiment, the feedback circuit includes the second coupling component and a third switch component. The second coupling component includes a second transmitting terminal and a second receiving terminal. The second transmitting terminal is coupled to the output terminal. The second receiving terminal is coupled to the control terminal of the first switch component. A control terminal of the third switch component is coupled to the second control unit to receive the first control signal, and the third switch component is controlled by the first control signal to be turned on or turned off. A first terminal of the third switch component is coupled to a ground terminal of the secondary-side module, and a second terminal of the third switch component is coupled to second transmitting terminal. When the third switch component is turned off, the second transmitting terminal provides the first feedback signal.

In one embodiment, the primary-side module further includes a first coupling component. The first coupling component includes a first transmitting terminal and a first receiving terminal. The first transmitting terminal is coupled to the second control unit. The first receiving terminal is coupled to the first control unit. The first transmitting terminal provides the second feedback signal to the first receiving terminal according to the second control signal.

In one embodiment, the detection unit includes a detection component. The detection component is coupled between the output terminal and the second control unit, and the detection component detects the load state at the output terminal to output the state voltage.

Accordingly, the present disclosure has the following features and advantages: under light-load operations, the efficiency of the power converter is optimized by simultaneously decreasing the front-stage voltage of the primary-side module and the output voltage of the secondary-side module.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block diagram of a conventional charger circuit.

FIG. 2A is a circuit diagram of an AC-to-DC rectifier and a primary-side conversion circuit in FIG. 1.

FIG. 2B is a circuit diagram of a secondary-side circuit in FIG. 1.

FIG. 3 is a block circuit diagram of a power converter according to the present disclosure.

FIG. 4A is a circuit diagram of a primary-side module of the power converter according to the present disclosure.

FIG. 4B is a circuit diagram of a secondary-side module of the power converter according to the present disclosure.

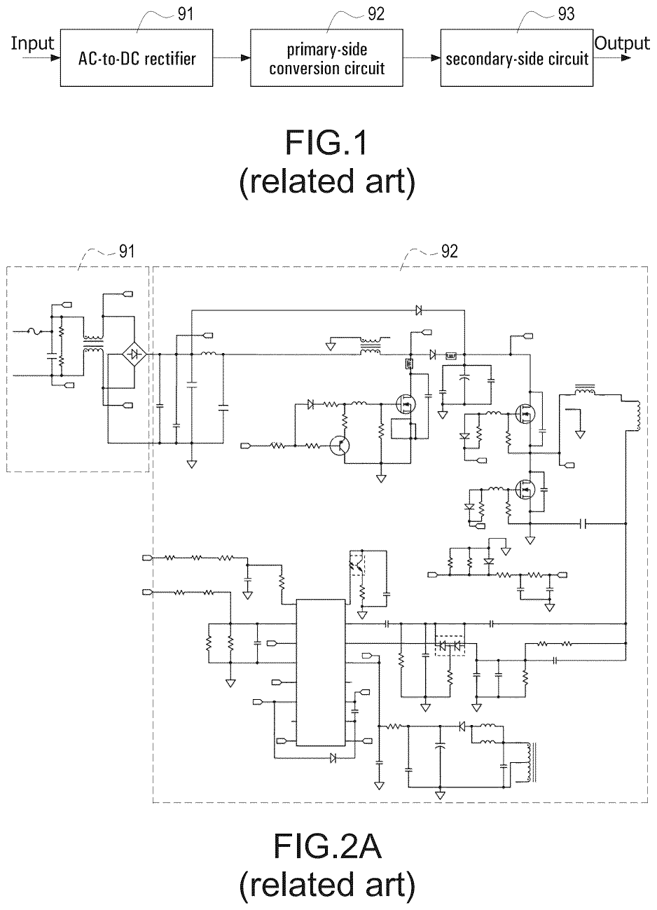

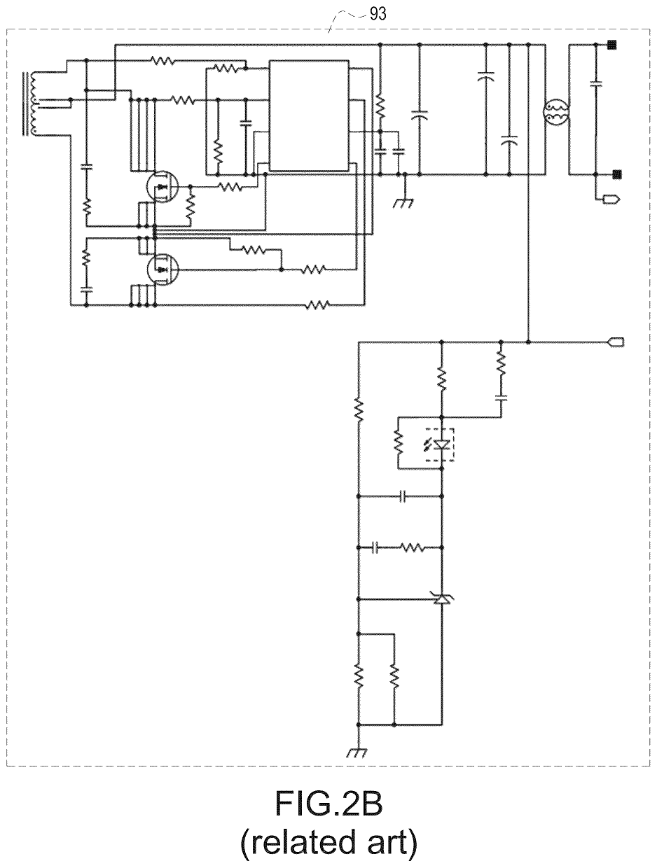

### DETAILED DESCRIPTION

Reference will now be made to the drawing figures to describe the present disclosure in detail. It will be understood that the drawing figures and exemplified embodiments of present disclosure are not limited to the details thereof.

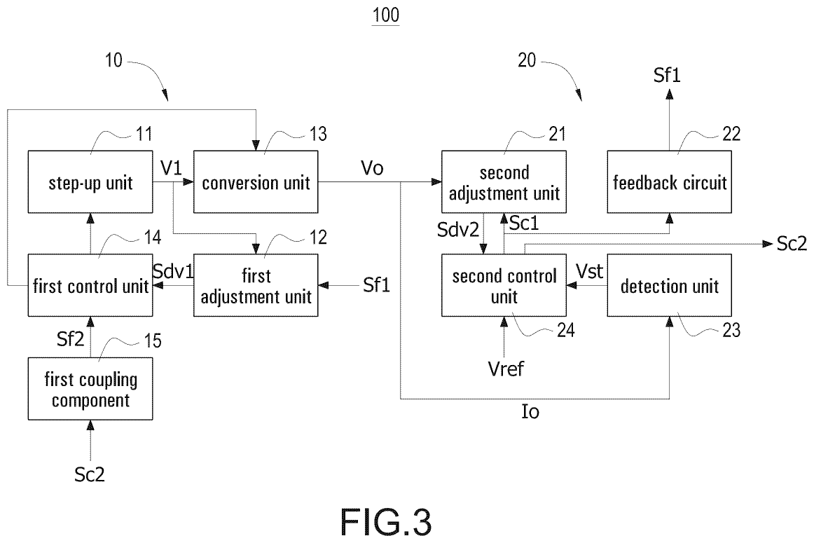

Please refer to FIG. 3, which shows a block circuit diagram of a power converter according to the present disclosure. The power converter 100 includes a primary-side module 10 and a secondary-side module 20. The primary-side module 10 includes a step-up unit 11, a first adjustment unit 12, a conversion unit 13, and a first control unit 14. The secondary-side module 20 includes a second adjustment unit 21, a feedback circuit 22, a detection unit 23, and a second control unit 24.

The step-up unit 11 provides a front-stage voltage V1. In one embodiment, the step-up unit 11 includes a power factor correction (PFC) unit. The first adjustment unit 12 is coupled to the step-up unit 11. The first adjustment unit 12 receives the front-stage voltage V1 provided by the step-up unit 11, and the first adjustment unit 12 outputs a first voltage-dividing signal Sdv1 according to the front-stage voltage V1 and a first feedback signal Sf1. The conversion unit 13 receives the front-stage voltage V1 provided by the step-up unit 11 and outputs an output voltage Vo. In one embodiment, the conversion unit 13 includes a resonant unit, for example, but not limited to, an LLC.

The first control unit 14 is coupled to the step-up unit 11, the first adjustment unit 12, and the conversion unit 13. The first control unit 14 receives the first voltage-dividing signal Sdv1 provided by the first adjustment unit 12, and the first control unit 14 controls the step-up unit 11 to adjust the front-stage voltage V1 according to the first voltage-dividing signal Sdv1, and controls the conversion unit 13 to adjust the output voltage Vo according to a second feedback signal Sf2. In one embodiment, the first control unit 14 may a control IC that controls the step-up unit 11 (i.e., including the PFC) and the conversion unit 13 (i.e., including the LLC).

The primary-side module 10 further includes a first coupling component 15. The first control unit 14 receives the second feedback signal Sf2 provided by the first coupling component 15 to control the conversion unit 13 so as to adjust the output voltage Vo. The operation of the first coupling component 15 will be described in detail later.

Please refer to FIG. 3 again. The secondary-side module 20 is electrically isolated from the primary-side module 10 through the conversion unit 13 and the feedback circuit 22. The secondary-side module 20 includes the second adjustment unit 21, the feedback circuit 22, the detection unit 23, and the second control unit 24. The second adjustment unit 21 receives the output voltage Vo provided by the conversion unit 13 of the primary-side module 10, and outputs a voltage-dividing signal Sdv2 according to the output voltage Vo and a first control signal Sc1.

The feedback circuit 22 provides the first feedback signal Sf1 to the first adjustment unit 12 of the primary-side module 10 according to the first control signal Sc1. The detection unit 23 outputs a state voltage Vst according to a load state at an output terminal OUT of the conversion unit 13 of the primary-side module 10, that is, the detection unit 23 outputs the state voltage Vst according to an output current Io of the conversion unit 13.

The second control unit 24 is coupled to the second adjustment unit 21, the detection unit 23, and the feedback circuit 22. The second control unit 24 receives the state voltage Vst provided by the detection unit 23, outputs the first control signal Sc1 to the second adjustment unit 21 and the feedback circuit 22 according to the state voltage Vst and a reference voltage Vref, receives the second voltage-dividing signal Sdv2 provided by the second adjustment unit 21, and outputs a second control signal Sc2 according to the second voltage-dividing signal Sdv2.

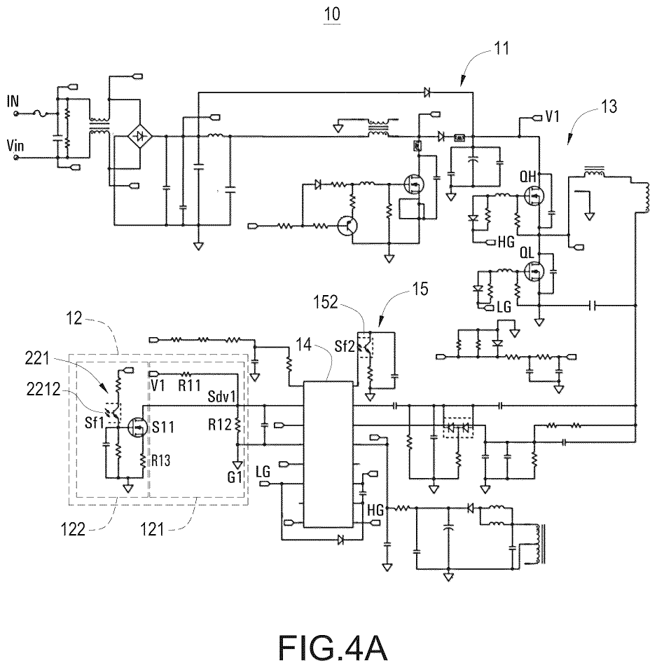

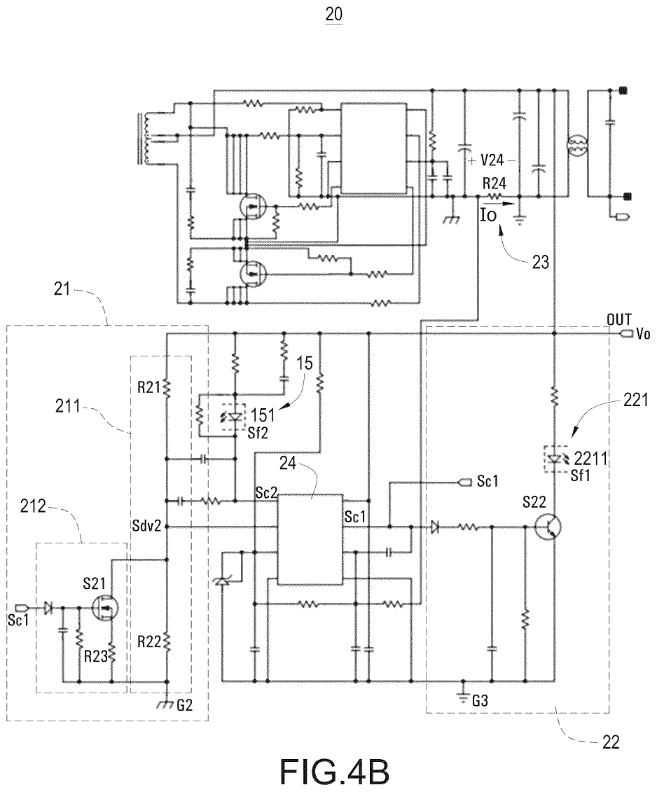

Please refer to FIG. 4A and FIG. 4B, which show circuit diagrams of a primary-side module and a secondary-side module of the power converter according to the present disclosure respectively, and also refer to FIG. 3.

In FIG. 4A, the first adjustment unit 12 includes a first voltage-dividing circuit 121 and a first voltage-transforming circuit 122. The first voltage-dividing circuit 121 is coupled to the step-up unit 11 and outputs a first voltage-dividing signal Sdv1. Specifically, the first voltage-dividing circuit 121 includes a first resistor R11 and a second resistor R12 connected in series. A first terminal of the first resistor R11 is coupled to the step-up unit 11 to receive the front-stage voltage V1 generated by the step-up unit 11, that is, a high-voltage output acquired after the step-up unit 11 converts the voltage in a step-up manner, for example but not limited, to 400 volts. A first terminal of the second resistor R12 is coupled to a ground terminal G1 of the primary-side module 10, that is, the first terminal of the second resistor R12 is not coupled to the first terminal of the first resistor R11. A second terminal of the first resistor R11, a second terminal of the second resistor R12, the first control unit 14, and the first voltage-transforming circuit 122 are coupled, and the first voltage-dividing signal Sdv1 is outputted at the coupled node.

The first voltage-transforming circuit 122 is coupled to the first voltage-dividing circuit 121, and receives the first feedback signal Sf1 provided by the feedback circuit 22. In FIG. 4A, the first voltage-transforming circuit 122 includes a first voltage-transforming resistor R13 and a first switch component S11. The first voltage-transforming resistor R13 is connected to the first voltage-dividing circuit 121 in parallel. A first terminal of the first switch component S11 is coupled to the second terminal of the first resistor R11 and the second terminal of the second resistor R12. A second terminal of the first switch component S11 is coupled to the first voltage-transforming resistor R13. A control terminal of the first switch component S11 is coupled to a second coupling component 221 to receive the first feedback signal Sf1 provided by the feedback circuit 22. Therefore, when the first switch component S11 is turned off according to the first feedback signal Sf1, the first voltage-transforming resistor R13 is not connected to the first resistor R11 or the second resistor R12. Specifically, in this embodiment, the second coupling component 221 may be an optical coupler (or photoelectric coupler, photoelectric isolator), which has a second transmitting terminal 2211 and a second receiving terminal 2212.

In FIG. 4B, the second adjustment unit 21 includes a second voltage-dividing circuit 211 and a second voltage-transforming circuit 212. The second voltage-dividing circuit 211 outputs the second voltage-dividing signal Sdv2 according to the output voltage Vo. Specifically, the second voltage-dividing circuit 211 includes a third resistor R21 and a fourth resistor R22 connected in series. A first terminal of the third resistor R21 is coupled to the output terminal OUT to receive the output voltage Vo. A first terminal of the fourth resistor R22 is coupled to a ground terminal G2 of the secondary-side module 20. A second terminal of the third resistor R21, a second terminal of the fourth resistor R22, the second control unit 24, and the second voltage-transforming circuit 212 are coupled, and the second voltage-dividing signal Sdv2 is outputted at the coupled node.

The second voltage-transforming circuit 212 is coupled to the second voltage-dividing circuit 211, and receives the first control signal Sc1 provided by the second control unit 24. In FIG. 4B, the second voltage-transforming circuit 212 includes a second voltage-transforming resistor R23 and a second switch component S21. The second voltage-transforming resistor R23 is connected to the second voltage-dividing circuit 211 in parallel. A first terminal of the second switch component S21 is coupled to the second terminal of the third resistor R21 and the second terminal of the fourth resistor R22. A second terminal of the second switch component S21 is coupled to the second voltage-transforming resistor R23. A control terminal of the second switch component S21 is used to receive the first control signal Sc1 provided by the second control unit 24. Therefore, when the second switch component S21 is turned off according to the first control signal Sc1, the second voltage-transforming resistor R23 is not connected to the third resistor R21 or the fourth resistor R22.

In FIG. 4B, the feedback circuit 22 includes a second coupling component 221 and a third switch component S22. The second coupling component 221 includes a second transmitting terminal 2211 and a second receiving terminal 2212 (see FIG. 4A). The second transmitting terminal 2211 is coupled to the output terminal OUT to receive the output voltage Vo. The second receiving terminal 2212 is coupled to the control terminal of the first switch component S11 of the first voltage-transforming circuit 122. A control terminal of the third switch component S22 is coupled to the second control unit 24, and receives the first control signal Sc1 provided by the second control unit 24 to turn on or turn off the third switch component S22. A first terminal of the third switch component S22 is coupled to a ground terminal G3 of the secondary-side module 20. A second terminal of the third switch component S22 is coupled to the second transmitting terminal 2211 of the second coupling component 221. Therefore, when the third switch component S22 is turned off, the second transmitting terminal 2211 of the second coupling component 221 provides the first feedback signal Sf1 for being received by the second receiving terminal 2212 of the second coupling component 221.

Please refer to FIG. 4A and FIG. 4B, as mentioned above, the first coupling component 15 includes a first transmitting terminal 151 (see FIG. 4B) and a first receiving terminal 152 (see FIG. 4A). The first transmitting terminal 151 is coupled to the second control unit 24, and the first receiving terminal 152 is coupled to the first control unit 14. When the first transmitting terminal 151 is turned off according to the second control signal Sc2, the second feedback signal Sf2 is provided to the first receiving terminal 152.

Furthermore, please refer to FIG. 4B, the detection unit 23 of the secondary-side module 20 includes a detection component R24, such as but not limited to, a resistor component. The detection component R24 is coupled between the output terminal OUT and the second control unit 24 to detect the load state of the output terminal OUT, thereby outputting the state voltage Vst. For example, if the detection component R24 is the resistor component, according to the current flowing through the detection component R24 (i.e., the output current Io), the larger the output current Io is, the larger the voltage across the detection component R24 (i.e., the state voltage Vst) is; conversely, the smaller the output current Io is, the smaller the voltage across the detection component R24 is. Therefore, the larger the state voltage Vst is, the heavier the load of the system is; conversely, the smaller the state voltage Vst is, the lighter the load of the system is, and therefore the load state of the system may be detected by using the detection component R24.

Hereinafter, the power converter of the present disclosure is described for simultaneously reducing the front-stage voltage V1 of the primary-side module 10 and the output voltage Vo of the secondary-side module 20 under light-load conditions to achieve the optimization of the efficiency of the power converter.

Under normal heavy-load conditions, the output current Io of the secondary-side module 20 flows through the detection component R24 and generates a detection voltage V24 across two terminals of the detection component R24. When the second control unit 24 determines that the operation is under heavy-load conditions according to the state voltage Vst (i.e., the corresponding detection voltage V24), for example, the second control unit 24 determines that the state voltage Vst is greater than the reference voltage Vref, the second control unit 24 provides the first control signal Sc1, such as a high-level signal to turn on the third switch component S22. Since the third switch component S22 is turned on, the second transmitting terminal 2211 of the second coupling component 221 sends the first feedback signal Sf1 to the second receiving terminal 2212 so that the first switch component S11 is turned on, and therefore the first voltage-transforming resistor R13 is connected to the second resistor R12 in parallel.

At the same time, the second control unit 24 provides the first control signal Sc1 with a high level to turn on the second switch component S21. At this time, the second voltage-transforming resistor R23 is connected to the fourth resistor R22 in parallel.

Furthermore, under heavy-load conditions, the output voltage Vo is to be regulated at, for example but not limited to, 20 volts, and therefore the first control unit 14 receives the second feedback signal Sf2 provided by the first coupling component 15, and adjusts duty cycles of control signals of an upper (high-side) switch QH and a lower (low-side) switch QL of the conversion unit 13 according to the second feedback signal Sf2, that is, adjusts the duty cycles of an upper switch control signal HG (for controlling the upper switch QH) and a lower switch control signal LG (for controlling the lower switch QL). For example, if the output voltage Vo decreases, the duty cycles of the upper switch control signal HG and the lower switch control signal LG are adjusted to increase so as to increase the output energy of the conversion unit 13 and increase the output voltage Vo. On the contrary, if the output voltage Vo increases, the duty cycles of the upper switch control signal HG and the lower switch control signal LG are adjusted to decrease to decrease the output energy of the conversion unit 13 and decrease the output voltage Vo, thereby maintaining the output voltage Vo at 20 volts for output power supply heavy-load conditions.

On the contrary, when the second control unit 24 determines that the operation is under light-load conditions according to the state voltage Vst (i.e., the corresponding detection voltage V24), for example, the second control unit 24 determines that the state voltage Vst is less than the reference voltage Vref, the second control unit 24 provides the first control signal Sc1, such as a low-level signal to turn off the third switch component S22, or does not provide the first control signal Sc1, which can also turn off the third switch component S22. Since the third switch component S22 is turned off, the second transmitting terminal 2211 of the second coupling component 221 does not send the first feedback signal Sf1 to the second receiving terminal 2212 so that the first switch component S11 is turned off, and the first voltage-transforming resistor R13 is not connected to the first resistor R11 or the second resistor R12. Therefore, since the first voltage-transforming resistor R13 is removed from the parallel-connected relationship with the second resistor R12, the first voltage-transforming resistor R13 no longer participates in the voltage division of the front-stage voltage V1. Therefore, the first voltage-dividing signal Sdv1 undergoes a transient voltage change. However, in order to maintain the voltage of the first voltage-dividing signal Sdv1 at a specific voltage, such as but not limited to 2.5 volts, when the system is in light-load operations, the first control unit 14 must control the front-stage voltage V1 outputted by the step-up unit 11 to decrease accordingly, for example, from 400 volts to 300 volts, to maintain the first voltage-dividing signal Sdv1 at this specific voltage.

At the same time, the second control unit 24 provides the first control signal Sc1 with a low level (or does not provide the first control signal Sc1) to turn off the second switch component S21. In this condition, the second voltage-transforming resistor R23 originally connected to the fourth resistor R22 in parallel is disconnected from the parallel-connected relationship with the fourth resistor R22. Therefore, since the voltage of the second voltage-dividing signal Sdv2 is fixed, such as but not limited to 2.5 volts, the output voltage Vo is decreased by removing the parallel-connected relationship of the resistors. Therefore, when the system is in light-load operations, the output voltage Vo is also decreased accordingly, for example but not limited to, 15 volts.

Similarly, under light-load conditions, the output voltage Vo is to be regulated at, for example but not limited to, 15 volts, and therefore the first control unit 14 receives the second feedback signal Sf2 provided by the first coupling component 15, and adjusts the duty cycles of control signals of the upper switch QH and the lower switch QL of the conversion unit 13 according to the second feedback signal Sf2, that is, adjusts the duty cycles of the upper switch control signal HG (for controlling the upper switch QH) and the lower switch control signal LG (for controlling the lower switch QL), thereby maintaining the output voltage Vo at 15 volts for output power supply under light-load conditions.

Accordingly, the present disclosure has the following features and advantages: under light-load operations, the efficiency of the power converter is optimized by simultaneously decreasing the front-stage voltage of the primary-side module and the output voltage of the secondary-side module.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A power converter comprising:
a primary-side module comprising:
a step-up unit configured to provide a front-stage voltage,
a first adjustment unit coupled to the step-up unit, and the first adjustment unit configured to output a first voltage-dividing signal according to the front-stage voltage and a first feedback signal,
a conversion unit configured to receive the front-stage voltage and output an output voltage, and
a first control unit coupled to the step-up unit, the first adjustment unit, and the conversion unit, and the first control unit configured to control the step-up unit to adjust the front-stage voltage according to the first voltage-dividing signal, and control the conversion unit to adjust the output voltage according to a second feedback signal, and
a secondary-side module electrically isolated from the primary-side module, and the secondary-side module comprising:
a second adjustment unit configured to output a second voltage-dividing signal according to the output voltage and a first control signal,
a feedback circuit configured to provide the first feedback circuit according to the first control signal,
a detection unit configured to output a state voltage according to a load state at an output terminal of the conversion unit, and
a second control unit coupled to the second adjustment unit, the detection unit, and the feedback circuit, and the second control unit configured to output the first control signal according to the state voltage and a reference voltage, and output a second control signal according to the second voltage-dividing signal.

2. The power converter as claimed in claim 1, wherein the first adjustment unit comprises:
a first voltage-dividing circuit coupled to the step-up unit, and the first voltage-dividing circuit configured to output the first voltage-dividing signal, and
a first voltage-transforming circuit coupled to the first voltage-dividing circuit, and the first voltage-transforming circuit configured to receive the first feedback signal.

3. The power converter as claimed in claim 2, wherein the first voltage-dividing circuit comprises a first resistor and a second resistor connected in series; a first terminal of the first resistor is coupled to the step-up unit, and a first terminal of the second resistor is coupled to a ground terminal of the primary-side module; a second terminal of the first resistor, a second terminal of the second resistor, the first control unit, and the first voltage-transforming circuit are coupled and configured to output the first voltage-dividing signal.

4. The power converter as claimed in claim 3, wherein the first voltage-transforming circuit comprises:
a first voltage-transforming resistor connected to the first voltage-dividing circuit in parallel, and
a first switch component, a first terminal of the first switch component coupled to the second terminal of the first resistor and the second terminal of the second resistor; a second terminal of the first switch component coupled to the first voltage-transforming resistor; a control terminal of the first switch component coupled to a second coupling component,
wherein when the first switch component is turned off according to the first feedback signal, the first voltage-transforming resistor is not connected to the first resistor or the second resistor.

5. The power converter as claimed in claim 1, wherein the second adjustment unit comprises:
a second voltage-dividing circuit configured to output the second voltage-dividing signal according to the output voltage, and
a second voltage-transforming circuit coupled to the second voltage-dividing circuit, and the second voltage-transforming circuit configured to receive the first control signal.

6. The power converter as claimed in claim 5, wherein the second voltage-dividing circuit comprises a third resistor and a fourth resistor connected in series; a first terminal of the third resistor is coupled to the output terminal, and a first terminal of the fourth resistor is coupled to a ground terminal of the secondary-side module; a second terminal of the third resistor, a second terminal of the fourth resistor, the second control unit, and the second voltage-transforming circuit are coupled and configured to output the second voltage-dividing signal.

7. The power converter as claimed in claim 6, wherein the second voltage-transforming circuit comprises:
a second voltage-transforming resistor connected to the second voltage-dividing circuit in parallel, and
a second switch component, a first terminal of the second switch component coupled to the second terminal of the third resistor and the second terminal of the fourth resistor; a second terminal of the second switch component coupled to the second voltage-transforming resistor; a control terminal of the second switch component configured to receive the first control signal,
wherein when the second switch component is turned off according to the first control signal, the second voltage-transforming resistor is not connected to the third resistor or the fourth resistor.

8. The power converter as claimed in claim 4, wherein the feedback circuit comprises:
the second coupling component comprising:
a second transmitting terminal coupled to the output terminal, and
a second receiving terminal coupled to the control terminal of the first switch component, and
a third switch component, a control terminal of the third switch component coupled to the second control unit to receive the first control signal, and the third switch component controlled by the first control signal to be turned on or turned off; a first terminal of the third switch component coupled to a ground terminal of the secondary-side module; a second terminal of the third switch component coupled to second transmitting terminal,
wherein when the third switch component is turned off, the second transmitting terminal is configured to provide the first feedback signal.

9. The power converter as claimed in claim 1, wherein the primary-side module further comprises:
a first coupling component comprising:
a first transmitting terminal coupled to the second control unit, and
a first receiving terminal coupled to the first control unit,
wherein the first transmitting terminal is configured to provide the second feedback signal to the first receiving terminal according to the second control signal.

10. The power converter as claimed in claim 1, wherein the detection unit comprises:
a detection component coupled between the output terminal and the second control unit, and the detection component configured to detect the load state at the output terminal to output the state voltage.
